(19) United States
(12) Patent Application Publication
(10) Pub. No.: US 2025/0289045 A1
(43) Pub. Date: Sep. 18, 2025

(54) PRE-EXTRUSION BILLET DESIGNS FOR IMPROVED METAL MATRIX COMPOSITES SYNTHESIZED BY SOLID PHASE PROCESSES

(71) Applicant: NAECO, LLC, Peachtree City, GA (US)

(72) Inventors: Guenther Horn, Glen Allen, VA (US); David C. Bergmann, Fayetteville, GA (US); Frederick C. Bergmann, Fayetteville, GA (US)

(73) Assignee: NAECO, LLC, Peachtree City, GA (US)

(21) Appl. No.: 19/222,923

(22) Filed: May 29, 2025

Related U.S. Application Data
(63) Continuation-in-part of application No. 18/437,721, filed on Feb. 9, 2024.
Application No. 18/437,721 is a continuation of application No. PCT/US2023/081824, filed on Nov. 30, 2023.
(60) Provisional application No. 63/385,490, filed on Nov. 30, 2022.

(51) Int. Cl. B21C 23/04; B32B 15/01; B32B 15/20; C22C 9/00

(52) U.S. Cl. CPC B21C 23/04; B32B 15/01; B32B 15/20; C22C 9/00; B32B 2311/12

(57) ABSTRACT

A billet adapted for use in a solid phase extrusion process to produce an extrudate, the billet including a billet body formed from Copper or Copper-Silver alloy, where the body defines a longitudinal void that extends along a longitudinal length of the body, powdered Graphene or powdered Carbon nano-tubes or nano-crystalline Carbon powder positioned in the longitudinal void and distributed evenly along the longitudinal length of the body, and where the weight percentage of the Carbon material relative to the metal in the body is between 10 ppm and 250 ppm, and where the billet is configured such that, after extrusion through the solid phase extrusion process to produce the extrudate, the extrudate has consistent conductivity is consistently greater than the conductivity of the Copper or Copper-Silver alloy.

### CROSS-REFERENCE TO RELATED APPLICATIONS

This application is a continuation-in-part of U.S. patent application Ser. No. 18/437,721 filed Feb. 9, 2024 which is a continuation of PCT/US2023/081824 filed Nov. 30, 2023 which claims the benefit of U.S. Provisional Application No. 63/385,490 filed Nov. 30, 2022, which are all hereby incorporated by reference.

### BACKGROUND

This disclosure relates to the field of extrusion of Metal Matrix Composite (MMC, or MMCs) including high conductivity MMCs using various metal extrusion technologies.

Hot Metal extrusion is a forming process in which a pre-material, known as a billet, is first heated, then forced through a die. This imparts the die shape to the extruded metal as it passes through the die. The material emerging from the die is known as “extrudate”. Hot metal extrusion can create rods, pipes, sheets, and other preliminary shapes useful for downstream large-scale production of wires, sheets, foils, tubes, profiles, etc.

A Metal Matrix Composite (MMC) is a primary metal with added fibers or particles dispersed as a second phase within the metallic matrix. The second phase material does not covalently bond with the metal, in other words, it is insoluble within the primary metal. Hereafter, the second phase is often described as a “non-metallic” or “additive”, to distinguish it from the primary metal.

For successful hot metal extrusion, it is not necessary to bring the metal to full molten state. Therefore, hot metal extrusion (HME) can use less energy and have fewer undesirable outcomes, such as metal oxidation or sublimation. Since the metal forms at a lower temperature state (called the plastic phase), in which the metal is still solid, hot metal extrusion is also sometimes referred to as a Solid Phase process. A relatively new type of extrusion is known as friction extrusion (FE), which operates at even lower temperatures than HME, but still within the range of plastic phase for metals. In this disclosure, we may interchangeably use the terms Hot Metal Extrusion (HME), Friction Extrusion (FE) or Solid Phase (SP) Processing. This is justified by the common use of Applicant's billet as input material, and similar operating temperature ranges of these processes.

There have been developments in manufacturing synthesized composite metals that are combined with non-metallic materials to produce new metal matrix composite (MMC) materials. Extrusion processes such as hot metal extrusion and friction extrusion have been used to combine metals, metal alloys and non-metallic materials to create MMCs. These extrusion methods fall under a broad group known as solid phase or solid state processing, hereafter referred to only as solid phase processing. Solid phase processes, including hot metal extrusion and friction extrusion, are distinguished from traditional wrought metallurgy because they operate below the melting point of the metal or metal alloy (versus fully melting the metal or metal alloy to a liquid state). Solid phase processes operate by plastically deforming the extruded metal. During solid phase processes, non-metallic materials are integrated with the metal or metal alloy while the metal or metal alloy is plasticized, thereby creating metal matrix composites that may have beneficial properties.

One such beneficial property is enhanced electrical conductivity (EC). Since the deployment of conductive metals surrounds us, from power lines to miniature electronics, any efficiency gains in basic conductors can have broad cross-cutting potential. Enhanced Conductivity is a very desirable outcome for an MMC material, and could contribute to more efficient electrical infrastructure and devices, thereby enabling lower carbon emissions. However, as important and far-reaching the potential benefits, the manufacture of consistent and useful quantities of EC materials have eluded many researchers and industries. We note there is no widespread commercial enhanced conductive MMC material in use today. Due to its important benefits, and the heretofore unsuccessful widespread commercial production, we used enhanced electrical conductivity as the benchmark property to measure the efficacy of this disclosure.

Solid phase processes may facilitate the creation of MMCs that otherwise might not be possible by traditional molten metallurgy methods. For example, allotropes of carbon, ceramics and other non-metallic materials are insoluble in metal and are not generally combinable with metal using traditional molten metallurgy methods.

Hot metal extrusion is a metal forming process that uses a pre-heated metal billet which is placed in a pre-extrusion chamber. The billet is generally heated above the recrystallization temperature of the metal in the billet but under the melting temperature of the metal. One side of the chamber contains a die with a desired cross section and the other side a ram that pushes the metal billet through the die. Metal plasticizes, flows through the profile of the die and, after solidification, takes the shape of the die. FIGS. 1A and 1B illustrate a prior art billet 40. Billet 40 is a generally cylindrical rod having a length L and a diameter D. An example billet 40 could have a diameter D of between 2 inches (5.1 cm) and 6 inches (15.2 cm) and a length L of up to 3 feet (91 cm). Other processes could use a billet with different dimensions.

Friction Extrusion (FE) also requires a billet as input material. FE typically rotates the billet relative to the extrusion die in combination with an extrusion force that is applied to push the billet against the die. Alternately, either the die may be rotated against a stationary billet, or billet may be rotated against a stationary die, or the die and billet can be counter-rotated against each other. The relative motion produces frictional heat and large shear stresses that plastically deform the layer of the billet in contact with and near the die. The friction between the die and billet produces sufficient heat, so friction extrusion generally does not require preheating the billet. The plastic deformation can promote metallurgical bonds between powder particles or other finely divided precursors that can improve consolidation of the billet prior to extrusion. While Friction Extrusion heats the material at the die-billet interface, the process can be controlled to maintain the temperature below the melting point of the billet.

Various MMC materials produced by hot metal extrusion and friction extrusion have exhibited other valuable characteristics including improved mechanical properties such as increased strength relative to the material weight. Such improved mechanical properties can result in lighter weight components and/or substitution of less expensive materials to achieve similar results.

MMCs consisting of Copper (Cu) combined with Graphene (GR) have shown improved electrical conductivity compared to pure Copper. Pure Copper is used for many low to medium voltage electrical conductors and conducting electromechanical components due to its high electrical conductivity (typically 100.0% IACS, or 5.8001×10⁷ Siemens/meter in metric units) and desirable mechanical properties. Graphene and other forms of nano-Carbon have significantly higher electrical conductivity than Copper (up to and over 800% IACS), although with less useful mechanical properties. Using various solid-phase processes such as hot metal extrusion or friction extrusion, MMCs made by adding Carbon nano materials such as Carbon nano-tubes (CNT), Graphene or other nano-particle forms of Carbon to Copper have shown improved electrical conductivity compared to pure Copper, while maintaining the useful mechanical properties of Copper. Other conductive metals, when homogenously synthesized into a MMC, would likely also realize gains in conductivity. However, prior art techniques for producing MMC material with such improved electrical conductivity have not produced materials with consistent beneficial properties such as improved conductivity on a scale that would permit mass production of enhanced conductivity material. For example, using prior art methods, the addition of Graphene into Copper by friction extrusion has shown only local increases of electrical conductivity up to 105%-106% IACS, but such increased conductivity was only present in short lengths (<10 cm) and was inconsistent along the length of the friction extruded wire samples. Just as a weak link can ruin a chain, inconsistency is the enemy of successful EC MMC manufacturing. Without sufficient homogeneity, the MMC might have negligible improvement, or have areas with worse properties than plain, unmodified metals (see Table 1 and FIG. 2). To further illustrate the need for improved consistency, prior art methods resulted in over 30% of the samples having areas of lower conductivity than unmodified copper (see Table 1 and FIG. 2).

TABLE 1
REFERENCE AND PRIOR ART CU-GR MMC,
PREPARED BY FRICTION EXTRUSION

| | Graphene | |
|---|---|---|
| | Content | Electrical Conductivity |
| Sample Description | [ppm] | [% IACS) |
| Pure Copper (Reference*) Nominal | 0 | 100 |
| Cu + Graphene MMC (A2-GR2)** | 8 | 99.7-100.5 |
| Cu + Graphene MMC (A3-GR3)** | 15 | 96.2-105.6*** |

*Source: Electrical Engineer's Reference Book (Sixteenth Edition), 2003
**Source: Battelle Pacific Northwest National Lab
***the best test section was not long enough to meet the ASTM B193 method

There is a need for improved methods of solid phase manufacturing of MMC materials that results in increased homogeneity of the key characteristics of the resulting MMC material. This application focuses on billet manufacturing techniques to create pre-extrusion forms that promote such homogeneity (See FIG. 1). Billets manufactured according to these methods can be subsequently fed into Hot Metal extrusion or Friction Extrusion, or other closely related solid phase processes.

There is a pressing need for Copper-based MMC materials with enhanced conductivity that can be produced consistently, preferably at industrial scale. With the broad use of copper and copper alloys (such as brass) as an electrical conductors in transformer windings, wires and busbars, electric motors, microelectronics, power control devices, heat sinks and more. Power Distribution Networks, electrified Industrial Processes, Electric Vehicles, Power Controls and Data Centers could waste less power. Even a small percentage increase in conductivity could enable a new class of more efficient conductors, thereby reducing energy waste and aiding in the fight against Greenhouse Gas (GHG) emissions. The methods taught herein could help meet the need for commercially feasible enhanced conductive MMC technology that have so far, eluded commercial manufacturers.

### BRIEF DESCRIPTION OF THE DRAWINGS

FIG. 1A is a side view of a prior art billet.

FIG. 1B is an end view of the FIG. 1A billet.

FIG. 2A is a side view of a prior art billet.

FIG. 2B is an end view of the FIG. 2A billet.

FIG. 3 is a side view of a prior art wire extruded from the FIG. 2A billet.

FIG. 4 is a metallographic microstructure evaluation of a Cu-Graphene wire friction-extruded from the FIG. 2A billet. The slice is tangential to the longitudinal axis of the wire.

FIG. 5 is an end view of a first billet.

FIG. 6 is an end view of a second billet.

FIG. 7 is an end view of a third billet.

FIG. 8 is an end view of a fourth billet.

FIG. 9 is an end view of a fifth billet.

FIG. 10 is an end view of a sixth billet.

FIG. 11 is a side cross-sectional view of the FIG. 10 billet.

FIG. 12 is an end view of a seventh billet.

FIG. 13 is a side cross-sectional view of the FIG. 12 billet.

FIG. 14 is an end view of an eighth billet.

FIG. 15 is a side perspective view of the FIG. 14 billet.

FIG. 16 is an end view of a ninth billet.

FIG. 17 is an end view of a tenth billet.

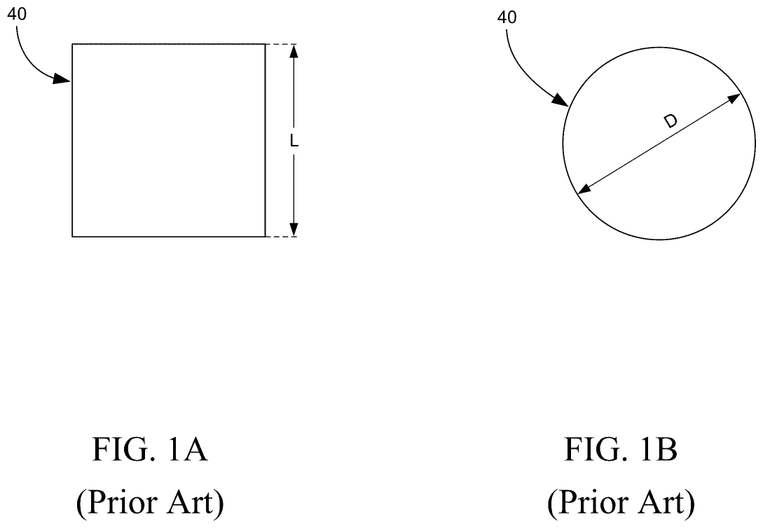

### DETAILED DESCRIPTION OF THE DRAWINGS

For the purpose of promoting an understanding of the principles of the claimed invention, reference will now be made to the embodiments illustrated in the drawings and specific language will be used to describe the same. It will nevertheless be understood that no limitation of the scope of the claimed invention is thereby intended. Any alterations and further modifications in the described embodiments, and any further applications of the principles of the claimed invention as described herein are contemplated as would normally occur to one skilled in the art to which the claimed invention relates. Embodiments of the claimed invention are shown in detail, although it will be apparent to those skilled in the relevant art that some features that are not relevant to the present claimed invention may not be shown for the sake of clarity.

With respect to the specification and claims, it should be noted that the singular forms “a”, “an”, “the”, and the like include plural referents unless expressly discussed otherwise. As an illustration, references to “a device” or “the device” include one or more of such devices and equivalents thereof. It also should be noted that directional terms, such as “left”, “right”, “up”, “down”, “top”, “bottom”, and the like, are used herein solely for the convenience of the reader in order to aid in the reader's understanding of the illustrated embodiments, and it is not the intent that the use of these directional terms in any manner limit the described, illustrated, and/or claimed features to a specific direction and/or orientation.

One reason to investigate MMC's is the pursuit of enhanced conductive materials. The inventors' experimentation was primarily with Copper, since it is the most common conductor, and also a Copper alloy, to learn if the methods could also apply to alloys. However, the methods taught herein could also apply to manufacture MMCs using other metals or alloys to achieve desirable electrical and mechanical properties. Data showing Enhanced Electrical conductivity results are described later within this application. Note that the Wiedemann-Franz principle teaches that thermal conductivity often correlates with electrical conductivity. Therefore, enhanced thermal conductivity properties, including improved Thermal Coefficient of Resistance (TCR) could also result from the methods described within this application.

According to Electrical Engineer's Reference Book (Sixteenth Edition), pure copper should have electrical conductivity at an average 100% International Annealed Copper Standard (100% IACS), with typical range of commercial copper materials of 99-101% IACS. The widely accepted test method ASTM B193-20, Standard Test Method for Resistivity of Electrical Conductor Materials, provides for an accuracy of ±0.30% on test specimens having a resistance of 0.00001Ω (10 μΩ) or more, minimum 30 cm length and consistent density and cross-sectional area. Commercial copper will have a conductivity range of 99-101% IACS. Applying six-sigma quality principles, a test result having a gain from the samples' starting conductivity of at least minimum six-times the 0.30% standard test variance, or 1.8% IACS minimum improvement from the baseline, begins to be justifiably considered as ‘significantly enhanced’. Using the ASTM B193-20 test method, Applicant's best sample to date measured at 104.2% IACS, which was 4.15% improvement from the control sample.

Were it possible, a direct way to check the homogeneity of MMC extrudates would be by photo micrographs showing good distribution of the nanoparticles within the metal matrix. However, today's lab instruments are not capable of precisely detecting the low concentrations (Parts-Per-Million less than 1500 PPM) of certain added nanomaterials, such as dispersed graphene, across large area cross-sections of a MMC. Without precise “photos” of the MMC extrudates, we must therefore judge the efficacy of Applicant's Copper-Graphene MMCs by carefully measuring the resultant properties, using accepted and reliable standard tests such as ASTM B193-20.

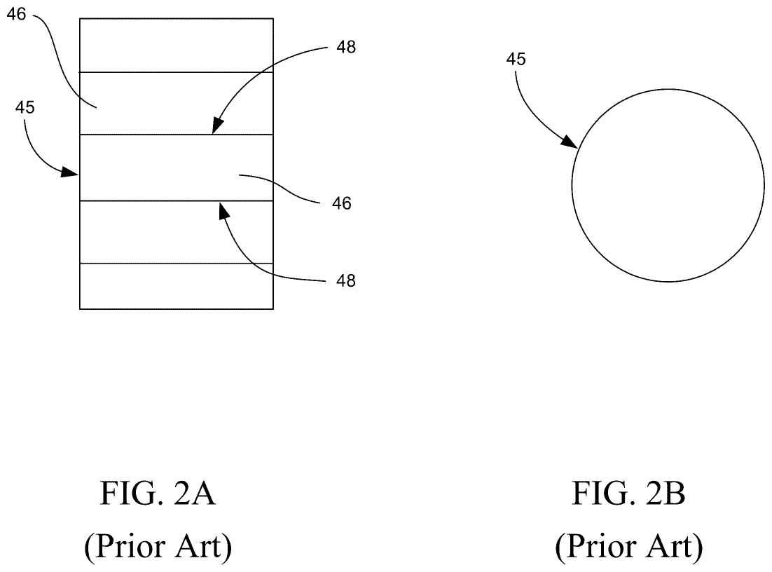

A potential issue identified by the Applicants in the prior art methods used to create enhanced conductive Copper-based MMC materials described above is the distribution of the non-metallic material in the billet that is extruded. One type of billet that has produced inconsistent results is shown in FIGS. 2A and 2B as billet 45. Billet 45 consists of a metallic cylinder of material sliced at a right angle to the longitudinal axis along the length of the cylinder to form several smaller cylinder segments 46. Metallic foil 48, that is coated with the non-metallic material, is positioned between adjacent cylinder segments 46 to form billet 45 in approximately the original cylindrical shape with the non-metallic material distributed along the length of the billet between each of the slices. Billet 45 is then processed using either friction extrusion or hot metal extrusion. Applicants had identified that this configuration does not adequately distribute the non-metallic material along the longitudinal length of the billet which may contribute to the resultant extruded Copper-based MMC material having varying material properties along the length of the MMC extrudate. This application teaches novel techniques for packaging the pre-materials (i.e. primary metal, plus additive), which can then promote more consistent and predictable solid phase extruded materials.

The novel billet preparation methods taught in this application are shown herein to yield more consistent composite outcomes than the prior art. Moreover, since solid phase hot metal extrusion processes require a billet as input material, the billet designs taught herein can subsequently be used in many existing types and sizes of HME or FE equipment.

Applicants' novel and positive outcomes have been recognized by the US Department of Energy—winning both First and Second Stages of the Conductivity-enhanced materials for Affordable, Breakthrough Leapfrog Electric and Thermal applications (CABLE) Conductor Manufacturing Prize. (See energy.gov—U.S. Department of Energy Awards $1.4 Million to Advance Affordable Conductivity Enhanced Materials and Applications Apr. 25, 2023 Article, The Advanced Materials and Manufacturing Technologies Office, Office of Science, US Department of Energy.) Stage 3 of the competition has not yet been released.

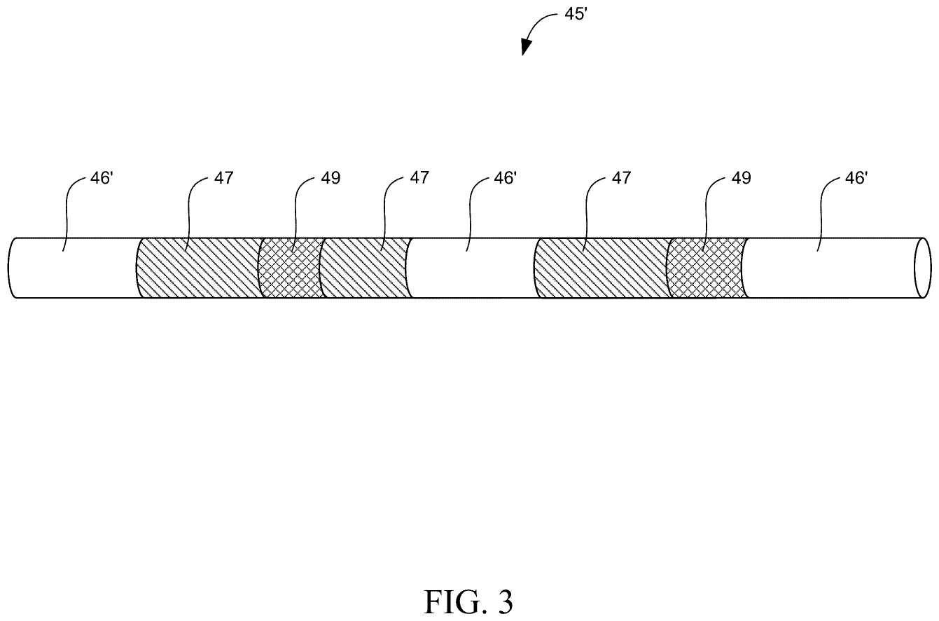

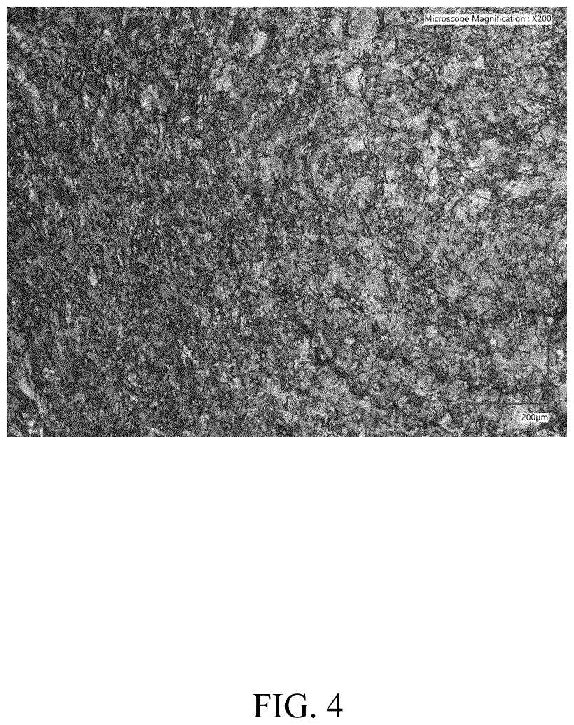

Referring to FIG. 3, a length of prior art Copper-based MMC is illustrated as wire 45′. Wire 45′ includes regions of nominal conductivity 46′, regions of enhanced (<2% over nominal) conductivity 47 and regions of reduced conductivity 49. Referring to FIG. 4, a metallographic microstructure evaluation of a friction-extruded Cu-Graphene wire using prior art methods is illustrated. The illustrated slice is perpendicular to the longitudinal axis of the wire. The right side of the image corresponds to the center of the wire and the left side of the image corresponds to an outer edge of the wire. Note the significant variation in grain size between the center of the wire and its outer edge regions, as well as material flow lines.

In principle, both Friction Extrusion and Hot Metal Extrusion keep the temperature of the billet below the melting temperature of the metal in the billet (the non-metallic material generally has a higher melting temperature than the metal). Producing fully dense Copper-based extrudate MMC materials with either Friction Extrusion or Hot Metal Extrusion requires an extrusion ratio of at least 20:1. Extrusion ratio is defined as the ratio of the cross-sectional area of the original billet to that of the extrudate. In other examples, extrusion ratios of 80:1 or 100:1 are used. After extruding the MMC, the MMC extrudate can be further shaped and processed using known metal process including, but not limited to, hot rolling, cold rolling, annealing and drawing.

Applicants have created new billet configurations for use in either friction extrusion or hot metal extrusion that result in improved distribution of the non-metallic material along the longitudinal length of the billet and throughout the subsequent MMC extrudate.

For Copper-based MMC materials, the desired amount of non-metallic material is measured in parts per million, so the overall amount of non-metallic material can be minuscule in comparison to the amount of metallic material in the billet. For example, a desirable weight percentage of Graphene compared to Copper to produce a Copper-Graphene MMC with enhanced conductivity, could be between 10 PPM to 250 PPM.

Each of the following billets are preferably created and/or processed in an atmosphere that is non-reactive to both the metal and non-metallic materials in the billet. For many materials the primary concern is the absence of Oxygen when material is heated to reduce or eliminate any oxidation that could occur. However, preferred atmospheric conditions can vary with different materials. In the case of Copper and Graphene, a Nitrogen or Argon atmosphere can be used when materials are heated.

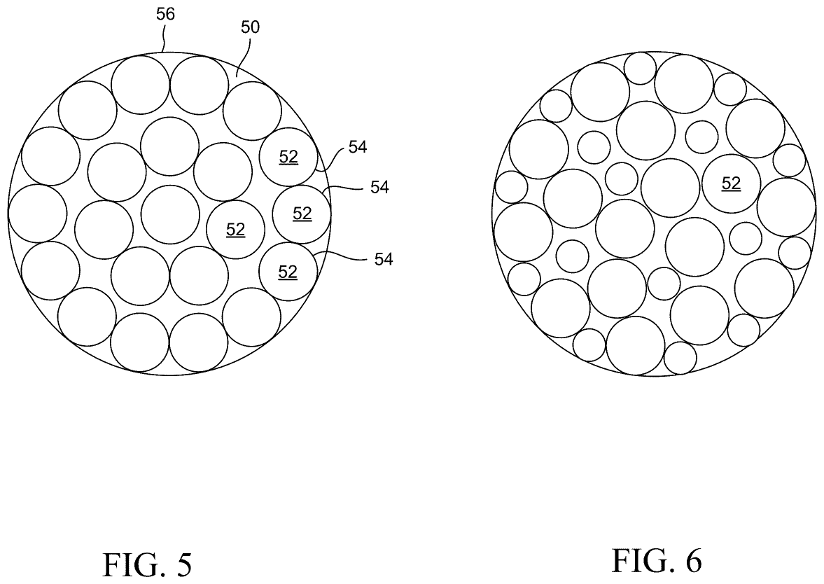

Referring to FIG. 5, billet 50 is illustrated. Billet 50 generally includes wires 52, coating 54 on wires 52 and jacket 56. Wires 52 are coated with coating 54 that can include the desired non-metallic material. Wires 52 are packed inside jacket 56. Wires 52 can each consist of the same metallic material or a different material can be used with different wires 52, depending on the desired MMC material. Coating 54 can be applied to every wire 52 or coating 54 can be applied to a subset of wires 52, depending on the amount of non-metallic material desired. Jacket 56 can consist of the same metallic material as wires 52 or a different material can be used, depending on the desired MMC material. Copper-Graphene MMC could be produced using Copper or Copper-Silver alloy wires that are coated with Graphene by any suitable physical or chemical deposition process.

Referring to FIG. 6, an alternative embodiment of billet 50 is illustrated. Billet 50 generally includes wires 52, wires 53, coating 54 on wires 52 and/or wires 53 and jacket 56. Wires 52 and 53 have different diameters. Wires 52 and 53 can consist of the same metallic material or a different material can be used in various wires, depending on the desired MMC material. Coating 54 can be applied to every wire 52 and/or wire 53 or coating 54 can be applied to a subset of wires 52, depending on the amount of non-metallic material desired. Jacket 56 can consist of the same metallic material as wires 52 or a different material can be used, depending on the desired MMC material. Copper-Graphene MMC could be produced using Copper or Copper-Silver alloy wires that are coated with Graphene, or a mix of pure Copper and Copper-Silver alloy wires in the same or different diameters coated with Graphene using any suitable physical or chemical deposition process.

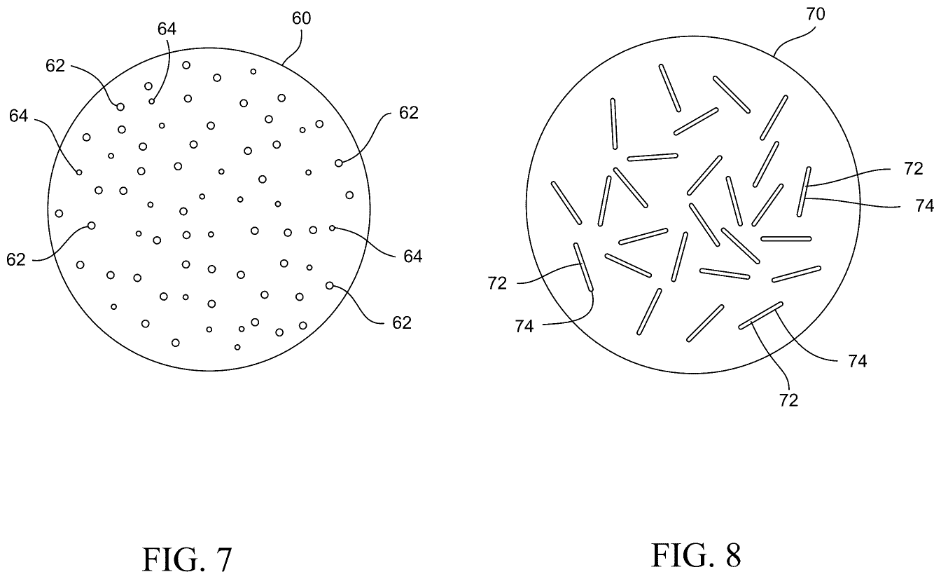

Referring to FIG. 7, billet 60 is illustrated. Billet 60 generally includes powder 62 and powder 64. Powder 62 can be a metallic material and powder 64 can be a non-metallic material. Billet 60 is formed as a cylinder by blending, pressing and, if advantageous or needed for the extrusion process chosen, sintering powders 62 and 64 together. Copper-Graphene MMC could be produced using powdered micron-sized Copper or Copper-Silver alloy and Graphene nano-platelets or any other nano-crystalline carbon in powder of flake form, for example Carbon nano-tubes.

Referring to FIG. 8, billet 70 is illustrated. Billet 70 generally includes metallic segments 72 coated with non-metallic material 74. Metallic segments 72 are pressed into the shape of billet 70. Metallic segments 72 could optionally comprise segments of metallic wire cut to length. Metallic segments 72 could have substantially uniform size, or the size could optionally vary between different metallic segments 72. In one example, metallic segments 72 are wire cut-offs that are coated with non-metallic material by processing the wire cut-offs and non-metallic material powder in a dry ball mill. Copper-Graphene MMC could be produced using Copper wire cut-offs and Graphene platelets or other carbon nano-crystalline material in powder form processed with Stainless Steel balls in the ball mill under a protective non-oxidizing atmosphere.

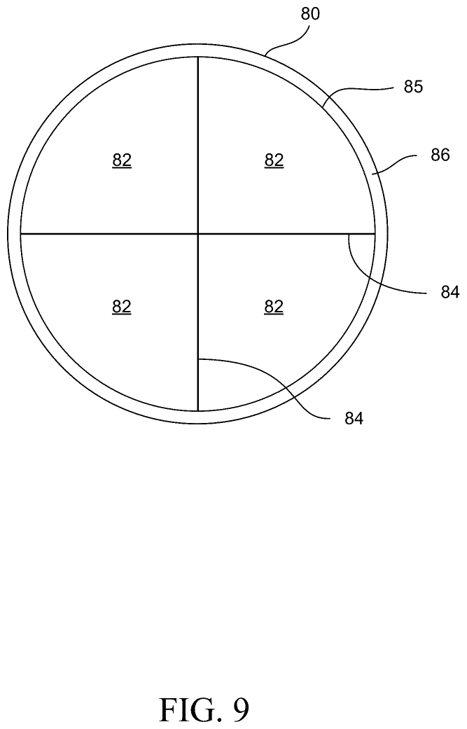

Referring to FIG. 9, billet 80 is illustrated. Billet 80 generally includes billet quarters 82, non-metallic material 84 and optional jacket 86. Billet quarters 82 can be formed by cutting a solid metal billet twice lengthwise. Non-metallic material 84 can be a foil containing the non-metallic material placed between adjacent quarters 82 and/or non-metallic material 84 can be coated onto the cut surfaces of billet quarters 82. Optional Jacket 86 surrounds the outside of billet quarters 82. In addition, radial surface 85 may optionally be coated with a non-metallic material. Note that while billet 80 shows 2 cuts forming quarters, other cuts could be used, including, but not limited to a single cut that halves the billet, additional cuts that pass through the center of the billet that further subdivide billet 80, for example, into 6 pieces, 8 pieces or more. And additional cuts that do not all pass through the center of the billet which also future subdivide billet 80, for example into square pieces rather than pie shaped pieces. Copper-Graphene MMC could be produced using a Copper or Copper-Silver alloy billet and Copper foil coated with Graphene placed between the cut segments.

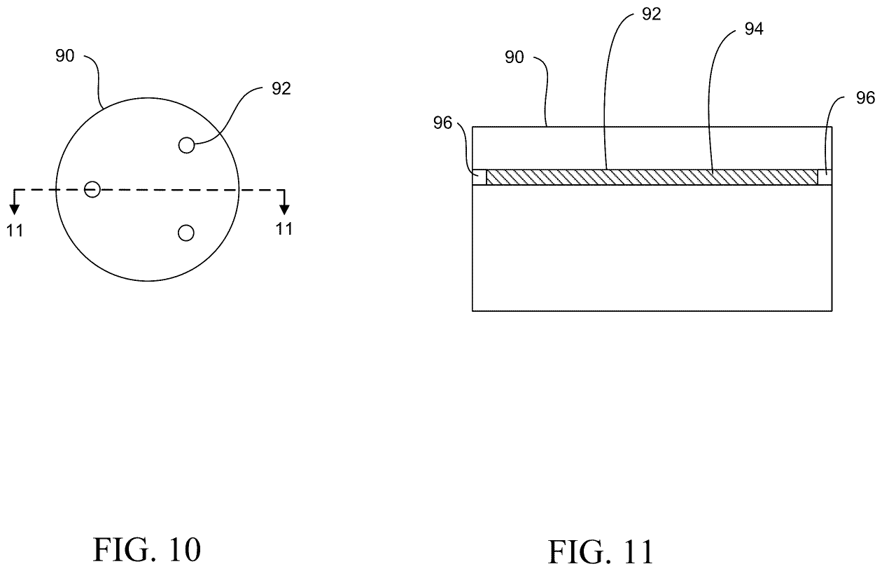

Referring to FIGS. 10 and 11, billet 90 is illustrated. Billet 90 generally includes one or more holes 92, fill 94 and end caps 96. Billet 90 is a metallic cylinder. One or more holes 92 are drilled along the longitudinal length of billet 90. Holes 92 can be spaced apart within the volume of billet 90. Holes 92 can be positioned at varying distances from a center axis of billet 90. Holes 92 are filled with fill 94. End caps 96 retain fill 94 within holes 92. Fill 94 can be powdered material such as Graphene platelets. Fill 94 can be tamped into holes 92. End caps 96 can be metallic material that corresponds to the material of billet 90, for example, a metallic plug pressed or welded in place. Copper-Graphene MMC could be produced using a Copper or Copper-Silver alloy billet and Graphene nano-platelets, Carbon nano-tubes or other nano-crystalline carbon forms in powder form as fill.

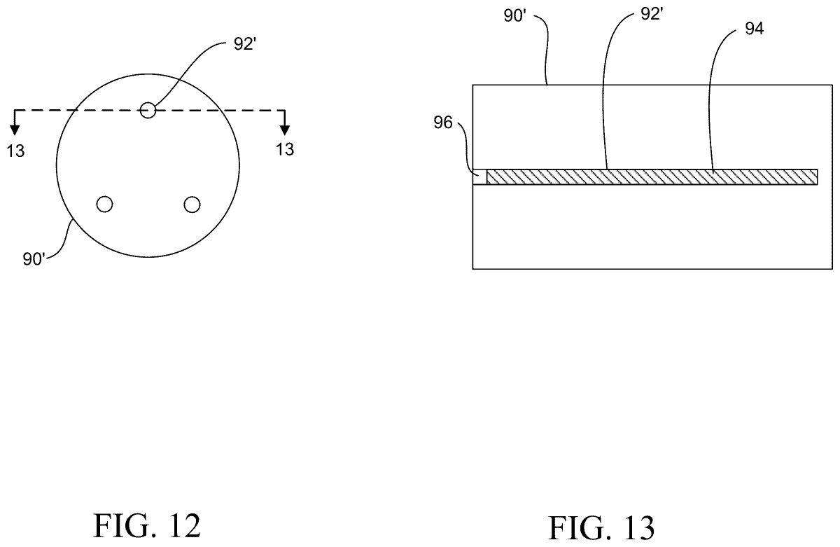

Referring to FIGS. 12 and 13, billet 90′ is illustrated. Billet 90′ generally includes one or more holes 92, fill 94 and end caps 96. Billet 90′ is a metallic cylinder. One or more holes 92′ are drilled along the majority of the longitudinal length of billet 90′. Note that holes 92′ are not through holes. Holes 92′ can be spaced apart within the volume of billet 90′. Holes 92′ can be positioned at varying distances from a center axis of billet 90′. Holes 92′ are filled with fill 94 as described above with reference to FIGS. 10 and 11. End caps 96 retain fill 94 within holes 92′.

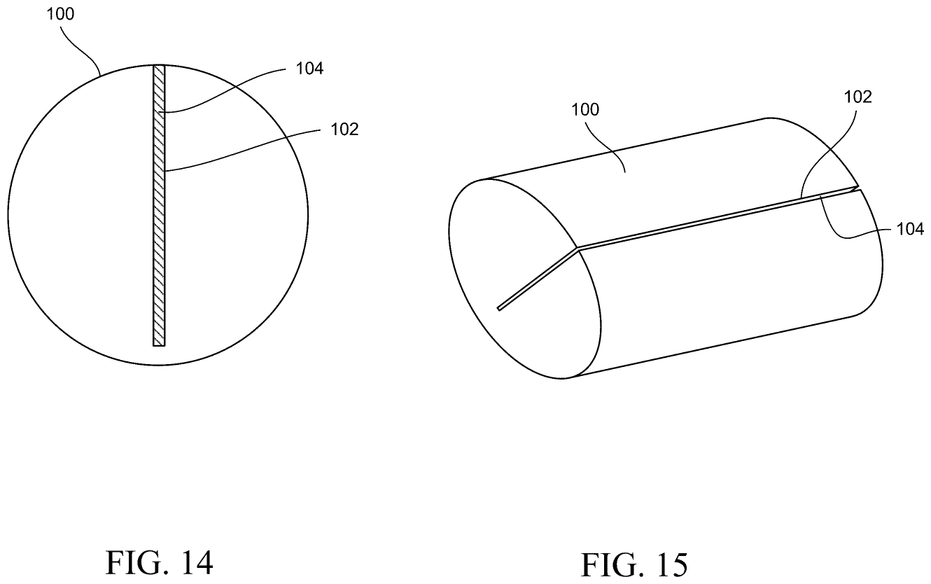

Referring to FIGS. 14 and 15, billet 100 is illustrated. Billet 100 generally includes one or more slices 102 each containing sheet 104. Slices 102 pass through a portion of billet 100 but do not sever billet 100 into separate segments. Slices 102 may extend along the longitudinal length of billet 100. Sheet 104 can be a foil containing the non-metallic material. Copper-Graphene MMC could be produced using a Copper or Copper-Silver alloy billet and Copper foil coated with Graphene placed in the slices.

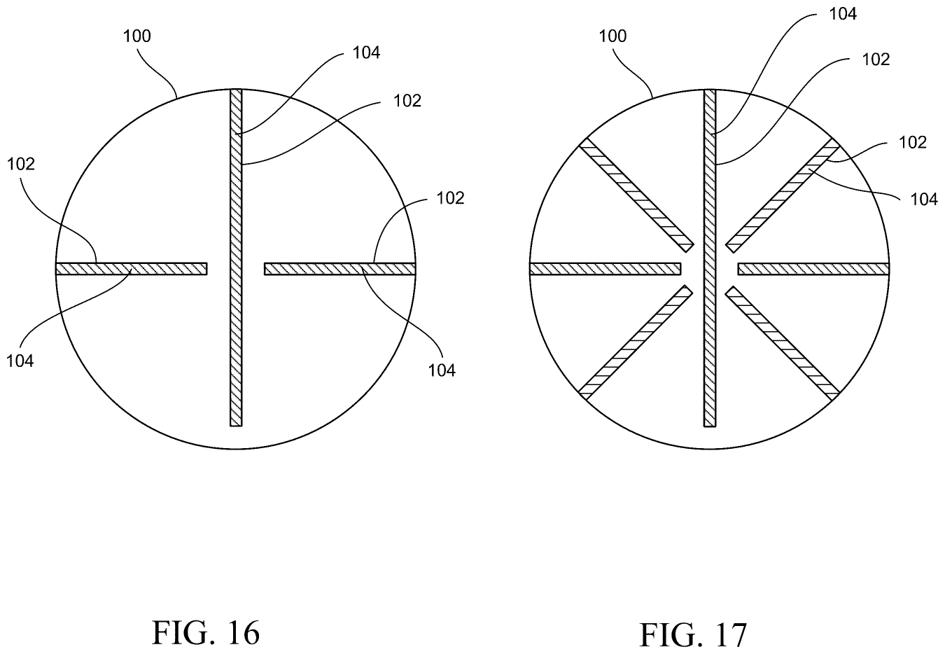

Referring to FIGS. 16 and 17, alternative embodiments of billet 100 are illustrated with different numbers and configurations of slices 102. As in FIGS. 14 and 15, each slice 102 contains a sheet 104 that contains the non-metallic material. FIG. 16 illustrates an embodiment with three slices and FIG. 17 illustrates and embodiment with seven slices. Different configurations and numbers of slices can be used to achieve a desired distribution of non-metallic material.

An enhanced conductive Copper-Graphene MMC can be made using either pure Copper or a Copper Alloy, in this case a Copper-Silver (CuAg) alloy with Ag content from 0.1 to 2.5 wt %. Our trial resulted in 3.1%-3.3% enhanced conductivity, and only +/−0.1% variance in outcome. (see Table 2 below). Note that use of a billet prepared using the methods disclosed in this application results in Enhanced and more consistent Electrical Conductivity, and facilitates higher levels of GR additive than Prior Art referenced on Table 1 (using the same solid phase process). Graphene can take the form of Graphene nano-platelets (GNP), Copper foil coated with Graphene and Carbon nano-tubes. Billet designs taught herein have yielded more consistent EC results (see Table 2), not more than +/−0.715% IACS variance as against +/−4.7% IACS variance for the prior art.

Consistent Mechanical Properties—in addition to checking for enhanced conductivity, we must confirm the MMC composites resulting from this disclosure have mechanical properties that are very similar to plain copper. Should the mechanical properties closely match copper, engineers could then use the material as a ‘drop-in’ upgrade for plain copper or copper alloy. Two important mechanical properties, Microhardness and % Elongation, will give such an indication. We present internal and independent comparisons showing good similarity to copper (see TABLE 5 and TABLE 6).

TABLE 2
PURE COPPER + GR MMC SAMPLE PREPARED
USING METHOD DESCRIBED WITHIN THIS APPLICATION.

| | Graphene | Electrical |
|---|---|---|
| | Content | Conductivity |
| Sample Description | [ppm] | [% IACS) |
| Pure Copper (Reference*) | 0 | 100 |
| Cu + Graphene MMC ** | 50 | 101.74-102.67 |
| Cu + Graphene MMC ** | 80 | 101.37-102.80 |
| 301 A-FE drwn | 50 | 103.39-103.85 |

*Source: Electrical Engineer's Reference Book (Sixteenth Edition), 2003
** Source: NAECO, per test Method ASTM B193B-20

TABLE 3
COPPER-SILVER ALLOY + GR MMC SAMPLE PREPARED
USING METHOD DESCRIBED WITHIN THIS APPLICATION.

| | Graphene | Electrical |
|---|---|---|
| | Content | Conductivity |
| Sample Description | [ppm] | [% IACS) |
| Copper Alloy**. | 0 | 98.0 |
| Cu Alloy + Graphene MMC** | 30 | 101.1-101.3 |

**Source: NAECO, per test Method ASTM B193B-2

TABLE 4
VICKERS MICRO-HARDNESS VALUES -
HV 0.1 - PLAIN METALS VS. MMCS

| | | HARDNESS Results (micro-indentation | | | |
|---|---|---|---|---|---|
| | | method, Vickers Scale 0.1 Kg weight) | | | |
| Sample | Sample | All readings taken in annealed state | | | |
| No. | Description | Result 1 | Result 2 | Result 3 | Average |
| 202 | Plain Copper | 48.3 | 47.0 | 46.5 | 47.27 |
| 264 | Copper Alloy | 49.3 | 52.0 | 55.9 | 52.40 |
| 265 | MMC 50 ppm-A | 43.4 | 46.8 | 47.2 | 45.80 |
| 266 | MMC 80 ppm-A | 54.8 | 59.9 | — | 57.35 |

Source: NAECO, LLC (2023)

TABLE 5
ELONGATION-% PER ASTM E8 FOR
OF PLAIN METALS VS MMCS

| Sample No. | Sample Description | Elong. % |
|---|---|---|
| N/A | Copper Literature -Reference | 55.0 |
| 260 | Copper Alloy | 56.4 |
| 264 | Copper Alloy | 55.1 |
| 265 | MMC 50 ppm-A | 53.3 |
| 266 | MMC 80 ppm-A | 48.3 |

Source: Applied Technical Services, LLC (2023)

TABLE 6
COMPARISON OF SAMPLE MASS OF
ENHANCED CONDUCTIVE MATERIALS

| | | Longest | | Mass of |
|---|---|---|---|---|
| | | continuous | Diameter of | continuous |
| | | section with | section with | section with |
| | | enhanced | enhanced | enhanced |
| Method of | | Electrical | Electrical | Electrical |
| Production | MMC Composition | Conductivity* | Conductivity* | Conductivity* |
| Prior Art | Cu + nano-carbon | 10 cm | 2.5 mm | 4.4 gr |
| This Application | Cu + nano-carbon | 30 cm | 6.0 mm | 75.4 gr |
| This Application | Cu Alloy + nano-carbon | 30 cm | 6.0 mm | 75.1 gr |
| This Application | Cu + nano-carbon | 143.9 | 5.5 mm | 295 gr |

Source: NAECO, LLC (2023)
(*MMC having minimum 2% improvement over pure metal with no additives)

The results of methods taught herein have yielded enhanced conductive outcomes having higher mass than the prior art, showing the billet design can support scale-up to larger production quantities (see TABLE 6 above).

The results of methods taught herein have been independently verified by private industry (see Table 7) and the US Department of Energy (see Table 8). This independent analysis considered samples prepared by the billet processing methods taught herein, followed by two different forms of Solid Phase Processing, Hot Extrusion and Friction Extrusion. Interestingly, the sample tested by Southwire, Inc. had undergone drawing and annealing, and was tested over a much longer test section.

TABLE 7
INDEPENDENT VALIDATION OF ENHANCED CONDUCTIVE
OUTCOME prepared by FRICTION EXTRUSION

| | Applicant's | Southwire's |
|---|---|---|
| | Result | Result** |
| Sample ID: “202” STANDARD | | |
| Unmodified Copper Input Metal | | |
| Test Section Length (cm) | 30 | 114.2 |
| Conductivity (% IACS), ASTM B193-20 | 100.19 | 100.10 |
| Sample ID: “301” | | |
| Copper-Graphene composite billet | | |
| prepared as per this disclosure, | | |
| followed by Solid Phase Processing | | |
| Test Section Length (cm) | 30 | 143.9 |
| Conductivity (% IACS), ASTM B193-20 | 103.10 | 102.72 |

*Both sites carefully measured ambient temperatures and factored in the Thermal Coefficient of Resistance (TCR) of Copper.
**Southwire, Inc. is a top global producer of power distribution wires and cables headquartered in Carrolton, Georgia, USA.
*** results are within the +/−0.30% variability of test method ASTM B193-20

TABLE 8
INDEPENDENT VALIDATION OF ENHANCED CONDUCTIVE
OUTCOME prepared by FRICTION EXTRUSION

| | Applicant's | US Department |
|---|---|---|
| | Result | of Energy Result* |
| Sample ID: “021 CF03” | | |
| Copper-Graphene composite billet | | |
| prepared as per this disclosure, | | |
| followed by Solid Phase Processing | | |
| Test Section Length (cm) | 30 | 30 |
| Conductivity (% IACS units)** | 103.34 | 103.04 |
| Sample ID: “018 CG07” | | |
| Copper-Graphene composite billet | | |
| prepared as per this disclosure, | | |
| followed by Solid Phase Processing | | |
| Test Section Length (cm) | 30 | 30 |
| Conductivity (% IACS units)** | 102.44 | 102.49 |

*SOURCE: US Department of Energy. Pacific Northwest National Lab. Battelle
**results are within the +/−0.30% variability of test method ASTM B193-20
*** starting conductivity was 100.1% IACS.

To further support large-scale manufacturing, real-world post-extrusion processes were performed in our samples. Drawing (diameter reduction by pulling the work piece through a die), followed by intermediate Annealing (re-heating work pieces to a soft state to allow further diameter reduction without becoming too brittle), are important steps in large-scale manufacturing. Testing proved that samples prepared using methods taught within this disclosure exhibited good workability in typical post-extrusion processes such as annealing and drawing. Independent Testing showed that samples retained good mechanical properties after 17.4% reduction of cross-sectional area by drawing through a reducing die from 5.5 mm nominal diameter to 5.0 nominal diameter (SEE TABLE 9). These results align with the mechanical testing data presented above, and showed good consistency as per our goals for this disclosure.

TABLE 9
INDEPENDENT MECHANICAL PROPERTY TEST RESULTS OF MMC
SAMPLES, FOLLOWED BY SUBSEQUENT DRAWING AND ANNEALING

| | | | | | | | | |
|---|---|---|---|---|---|---|---|---|
| | | | 0.2% | | Ultimate | 0.2% | | |
| Sample | Sample | UTS | Yield | Elongation | Load | Yield | Diameter | Area |
| No. | Desc. | (Mpa) | Strength | % | (N) | (N) | (mm) | (mm²) |

BEFORE DRAWING: As-extruded properties

| | | | | | | | | |
|---|---|---|---|---|---|---|---|---|
| 260 | Copper | 280 | 265 | 33.5 | 6637 | 6063 | 5.49 | 23.67 |
| | Alloy | | | | | | | |
| | CuAg | | | | | | | |
| 264 | Copper | 276 | 244 | 37.5 | 6528 | 5773 | 5.49 | 23.67 |
| | Alloy | | | | | | | |
| | CuAg | | | | | | | |
| 265 | MMC | 240 | 206 | 34.5 | 5685 | 4872 | 5.49 | 23.67 |
| | 50-A | | | | | | | |
| 266 | MMC | 241 | 206 | 38.0 | 5703 | 4879 | 5.49 | 23.67 |
| | 80-A | | | | | | | |

AFTER DIE DRAWING: Properties after 17.4% Reduction in area

| | | | | | | | | |
|---|---|---|---|---|---|---|---|---|
| 260 | Copper | 343 | 333 | 12.0 | 6710 | 6503 | 4.99 | 19.56 |
| | Alloy | | | | | | | |
| | CuAg | | | | | | | |
| 264 | Copper | 348 | 334 | 10.5 | 6810 | 6527 | 4.99 | 19.56 |
| | Alloy | | | | | | | |
| | CuAg | | | | | | | |
| 265 | MMC | 306 | 297 | 12.0 | 5992 | 5800 | 4.99 | 19.56 |
| | 50-A | | | | | | | |
| 266 | MMC | 303 | 291 | 11.0 | 5918 | 5698 | 4.99 | 19.56 |
| | 80-A | | | | | | | |

Source: Applied Technical Services, LLC Marietta Georgia (2023)

Copper Alloys are very often used in place of plain copper, for cost, availability and mechanical reasons. In this disclosure, in addition to studying plain copper, we prepared copper alloy billets with graphene additive to see if the disclosed methods to create useful MMC composites might work similarly for copper alloys. Using enhanced conductivity as a benchmark, we saw significant increase in electrical conductivity for our copper alloy, giving us reason to believe our method could work in the world of alloys, which is comparatively much larger and more chemically diverse than single element metals (see Table 10).

TABLE 10
COPPER-SILVER ALLOY + GR MMC SAMPLE PREPARED USING
METHOD DESCRIBED WITHIN THIS APPLICATION.

| | Graphene | Electrical |
|---|---|---|
| | Content | Conductivity* |
| Sample Description | added | (% IACS) |
| CuAg Copper Alloy control sample | No | 98.0 |
| CuAg Cu Alloy + Graphene MMC * | Yes | 101.1-101.3** |
| | | (3.1%-3.3% |
| | | improvement from the |
| | | control sample) |

*Source: NAECO, per test Method ASTM B193-20,
**n = 10 samples

NAECO, LLC, Southwire, LLC and Applied Technical Services, LLC, whose data are cited above in tables 2-10 respectively, have multiple quality and testing certifications (See TABLE 11).

TABLE 11
ACCREDITATIONS AND CERTIFICATIONS FOR PRIVATE
COMPANIES CITED WITHIN THIS DISCLOSURE

| Company | Accreditation/Certification | Description |
|---|---|---|
| NAECO, LLC | AS9100: D, ISO9001: 2015 | Aerospace, and General |
| | | Quality Management |
| | | Systems for manufacture |
| | | of electrical sub- |
| | | components |
| | ISO 13485: 2016 | Medical Device |
| | | Manufacturing |
| Applied Technical | ANSI/NCSL Z540-1 | General Requirements for |
| | | Calibrations Laboratories |
| | | and Measuring and |
| | | Testing Equipment |
| Services, LLC | 10 CFR Part 21 | Reporting of Defects and |
| | | Noncompliance |
| | ISO/IEC 17025 | General Requirements for |
| | | the Competence of |
| | | Testing and Calibrations |
| | | Laboratories |
| Southwire, LLC | ISO9001: 2015 | Wire and Cable Products |
| | | Manufacturing |

Other property-enhancing nano-particles not specifically named within this application may be likewise incorporated with metals under the methods described within this patent. New property-enhancing nano-materials are under continuous development, for example: Single Layer graphene, Few Layer graphene, 3-dimensional graphene, MXenes, or similar non-metallic nano-particles. In addition to non-metallics, metallics or inter-metallics which are otherwise insoluble in the primary metal, may also be homogeneously integrated into MMCs using the techniques described within this application.

Other types of MMCs that could be produced using the methods disclosed in this paper include, but are not limited to, combinations using primary metals including, but not limited to, the common highly conductive metals: Copper (a transition metal group element)) and Copper Alloys, Aluminum (a metal group, sometimes referred to as a post-transition group, element) and Aluminum Alloys, Silver (a metal group element) and Silver alloys, Iron (a transition metal group element) and Alloys/Steels, Noble Metals (a subgroup of the transition metals that includes Platinum, Palladium, Iridium, etc.), Cadmium (an alkaline earth metals group element).

While the present disclosure has been illustrated and described in detail in the drawings and foregoing description, the same is to be considered as illustrative and not restrictive in character, it being understood that a preferred embodiment has been shown and described and that all changes, equivalents, and modifications that come within the spirit of the claimed invention defined by following claims are desired to be protected.

The language used in the claims and the written description and in the above definitions is to only have its plain and ordinary meaning, except for terms explicitly defined above. Such plain and ordinary meaning is defined here as inclusive of all consistent dictionary definitions from the most recently published (on the filing date of this document) general purpose Merriam-Webster dictionary.

1. A billet used to produce a Copper Carbon metal matrix composite extrudate with enhanced conductivity, wherein the billet is adapted for use in a solid phase extrusion process selected from the group consisting of hot metal extrusion and friction extrusion, the billet comprising:
a billet body formed from a metal selected from the group consisting of Copper and Copper-Silver alloy, wherein the billet body defines a longitudinal void that extends along a longitudinal length of the billet body;
a Carbon material selected from the group consisting of powdered Graphene, powdered Carbon nano-tubes and nano-crystalline Carbon powder positioned in the longitudinal void, wherein the Carbon material is distributed evenly along the longitudinal length of the billet, and wherein the weight percentage of the Carbon material relative to the metal in the billet body is between 10 ppm and 250 ppm; and
wherein the billet is configured such that, after extrusion through the solid phase extrusion process to produce the extrudate, the extrudate possesses consistent conductivity along the longitudinal length of the extrudate that is consistently greater than the conductivity of the billet body.

2. The billet of claim 1, wherein the longitudinal void is a lengthwise linear cut that extends into or through the billet body.

3. The billet of claim 2, further comprising a Copper foil coated with the Carbon material, wherein the Copper foil is positioned within the lengthwise linear cut.

4. The billet of claim 2, wherein the lengthwise linear cut extends completely through a width of the billet body.

5. The billet of claim 4, further comprising a metallic jacket that surrounds and contains the billet body.

6. The billet of claim 1, wherein the longitudinal void is a first hole that extends into or through the billet body.

7. The billet of claim 6, wherein the Carbon material is positioned within the first hole.

8. The billet of claim 7, wherein the billet body defines a second hole that extends into or through the billet body, wherein the second hole extends along a longitudinal length of the billet body and wherein the Carbon material is positioned within the second hole.

9. The billet of claim 7, wherein the Carbon material is tamped within the first hole.

10. The billet of claim 7, further comprising a cap adapted to retain the Carbon material within the first hole.

11. The billet of claim 1, wherein the billet body comprises a plurality of metal wires that define a plurality of longitudinal voids between adjacent wires and wherein at least one of the plurality of metal wires is coated with the Carbon material.

12. The billet of claim 11, further comprising a metallic jacket that surrounds and contains the plurality of metal wires.

13. The billet of claim 1, wherein the weight percentage of the Carbon material relative to the metal in the billet body is between 10 ppm and 80 ppm.

14. The billet of claim 1, wherein the weight percentage of the Carbon material relative to the metal in the billet body is between 30 ppm and 250 ppm.

15. The billet of claim 1, wherein the weight percentage of the Carbon material relative to the metal in the billet body is between 50 ppm and 250 ppm.

16. The billet of claim 1, wherein the weight percentage of the Carbon material relative to the metal in the billet body is between 10 ppm and 50 ppm.

17. The billet of claim 1, wherein the weight percentage of the Carbon material is selected to increase the conductivity of the Copper Carbon metal matrix composite relative to the billet body.

18. The billet of claim 1, wherein the billet body is formed from Copper-Silver alloy.

19. The billet of claim 13, wherein the weight percentage of Silver in the Copper-Silver alloy is between 0.1 and 2.5 percent.

20. The billet of claim 1, wherein the billet is adapted for use in a solid phase extrusion process with an extrusion ratio of at least 80:1.

21. The billet of claim 1, wherein the billet is formed from pressed metallic wire cut-offs that are coated with the Carbon material.

22. The billet of claim 1, wherein the billet is formed from sintered metallic and Carbon material powders.
